(19) United States
(12) Patent Application Publication
(10) Pub. No.: US 2005/0034605 A1
(43) Pub. Date: Feb. 17, 2005

(54) Clamshell coffee and tea packet beverage brewer

(76) Inventors: Joseph P. Webster, St. Charles, MO (US); Jack Greenwood III, Edwardsville, IL (US)

Correspondence Address: Paul M. Denk, Suite 170, 763 S. New Ballas Road, St. Louis, MO, 63141, US

(21) Appl. No.: 10/917,501

(22) Filed: Aug. 12, 2004

Related U.S. Application Data
(60) Provisional application No. 60/495,761, filed on Aug. 15, 2003.

(51) Int. Cl. A47J 31/00

(52) U.S. Cl. 99/279

(57) ABSTRACT

The clamshell coffee or other beverage packet brewer, wherein a clamshell, with a hinged or discrete upper and lower halves, incorporate a cavity therein, into which a packet or scoop of grounds can locate. The clamshell, when closed, provides a hydraulic seal, with hot water being delivered leak proof to the clamshell apparatus, when inserted into the dispenser, for receiving a portion controlled size or quantity of the heated water passing through the grounds, and dispensing, by gravity, out of the dispenser and downwardly into an individual serving cup. The clamshell contains integrally its own spray head, for dissemination of the heated water onto the packet of grounds, and a contoured bottom, for flow of the instant brewed beverage towards a delivery aperture for descending downwardly into the individual positioned cup.

### CROSS-REFERENCE TO RELATED APPLICATIONS

This application is a regular letters patent application which claims benefit to the provisional patent application having Ser. No. 60/495,761 filed on Aug. 15, 2003.

### BACKGROUND OF THE INVENTION

Beverage brewers have now been in vogue for many, many years. Usually, the standard beverage brewer includes a dispenser, with a water reservoir, where the water therein is heated, rises up and is dispensed through a siphon tube to a basket containing a filter filled with a supply of ground coffee, where the hot water is deposited, the beverage is brewed by leaching, and then dripped into a decanter or pot for filling. This is a standard type of beverage brewer that has been around for many years. Similar type of brewing can be done with respect to tea, by siphoning hot water thorough a supply of grounds. Likewise, chocolate is brewed through mixing of hot water and supply of chocolate, can be dispensed into cups as is likewise done with coffee and tea. But, in the latter instance the coffee and tea is already brewed, and is simply dispensed from the brewer into the cup, for individual service.

There are a variety of U.S. patents that have long been available disclosing various types of beverage brewing devices. For example, one of the earlier embodiments of a custom beverage brewery shown in U.S. Pat. No. 4,829,888, to one of the inventors described herein, and shows a beverage brewer that includes the water heating tank, the heated water is transferred to a spray head, onto a basket of beverage grounds, for dripping of the brewed beverage into a decanter, for eventual service and consumption.

Other U.S. patents show various types of beverage brewers, such as U.S. Pat. No. 3,260,190, to Levinson, that discloses equipment adaptable to brewing coffee in the original sealed container. It appears that the receptacle shown therein, holds some type of a packet of coffee, when set up for brewing.

The patent to Classen, U.S. Pat. No. 3,755,895, shows what is described as a herb spoon. This is for use for providing a scoop of a dosage of a herb in preparation for usage, and while it does not relate to the brewing of any beverage per se, it does show a portion controlled means for delivery of an item, for subsequent usage.

The patent to Kataoka, U.S. Pat. No. 4,584,101, shows a coffee package, used for application into a coffee brewer, and for the preparation of such a beverage. This device does disclose means for individual brewing of a cup of coffee.

The patent to Vernon, et al, U.S. Pat. No. 5,135,762, shows a compartmental infusion packet. This packet appears to show a tea bag style of envelope for the brewing of tea, as explained therein.

The patent to Christie, et al, U.S. Pat. No. 5,478,581, shows an infusible pouch and cover. This infusible pouch and cover assembly, for a coffee or tea pouch, does show a cover arrangement, but it appears that this is more for protecting the pouch following preparation, rather than using any type of a clamshell arrangement for a beverage brewer.

The patent to Blanc, U.S. Pat. No. 5,776,527, shows another package of ground coffee of the pre-filled tablet type and espresso coffee machine using such a package. This shows that an espresso machine can include a pouch by simply placing the same into a chamber for brewing.

The patent to Fuentes, U.S. Pat. No. 6,034,754, shows another type of coffee maker filter holder system. It discloses the usage of a pouch for application to the filter, during coffee brewing.

The patent to Santi, U.S. Pat. No. 6,345,570, discloses an overall brewing device for feeding pre-compressed single-serving pods into the machine for the production of espresso coffee beverages. The pods is shown, but it does not appear to be used or in combination with any type of a clamshell arrangement.

Finally, they patent to Haydon, U.S. Pat. No. 6,354,190, shows another beverage making apparatus. The coffee made in this apparatus, which may be doctored with a measure of Irish whiskey, locates within a compartment, incorporating filters that are arranged above and below the same. But, these are not a clamshell type of arrangement.

This discloses the various type of prior art that is available relating to the technology of this current invention.

### SUMMARY OF THE INVENTION

This invention relates principally to a beverage brewing apparatus, that may be used for the brewing of coffee, tea, or any other type of beverage, wherein individual portion controlled type of means for use for holding smaller quantity of the grounds from which the beverage is brewed, usually for individual serving sized beverage, dispensed directly into a cup, and thereby provides a fresh cup of coffee, tea, or the like, whenever required, and it is readily brewed and dispensed, for instant consumption. Freshness for a brewed beverage for individual consumption in a more efficient and tastily method.

Essentially, this invention contemplates the formation of an individual dispenser, which may include means for holding a quantity of water, the heating of the same, the delivery of the water to the area where and individual and portion controlled packet of grounds are sustained, passing the hot water through the grounds, and dripping it downwardly into an arranged cup, for instant brewing and availability.

Essentially, the dispensing aspects of this invention are quite related to that as shown and explained in the prior art, and for that purpose, a definition as to how a beverage brewer functions and operates, of the prior art type, can be readily determined by reference to our prior U.S. Pat. No. 4,829,888 whose teachings are incorporated herein by reference.

Essentially, the essence of this invention is the structured formation of a clamshell type of device, that can be used for holding individual serving sized packets of the grounds to be brewed, whether it be coffee, tea, or the like. The clamshell device includes a base portion, with a pivotally connected lid, which can be sealed into closure, through the use of an o-ring, or other sealing means, when the two halves are pivoted into a closed condition. Internally of the clamshell design is a cavity into which a packet of grounds may be located, and such a packet can include an individual paper type of envelope that encloses a quantity of grounds for brewing a dispensing of a singular sized cup of beverage, for dispensing into a cup or a vessel. In addition, the clamshell may include space, within its cavity, for holding a scoop or basket, of individual serving size, for holding the various ground, and which can be laid into the cavity of the clamshell device, and into which the hot water can be delivered, for filtration through the grounds, out of its filtered or foraminous bottom, for delivery to an opening for dispensing downwardly into a cup as a freshly brewed cup of coffee, tea, or the like.

The clamshell structure of this invention includes various designed structures, that allows for the plug-in of the clamshell directly to the dispenser, and sealing upon its out-water delivery conduit or line so that no leakage occurs thereat. Then, the dispenser delivers a portion and time controlled the amount of hot water, normally in the quantity and volumetric capacity of a singular cup of beverage, when brewed, through a spray head, integrally formed within the upper half of the clamshell, for passing through the packet or scoop of grounds, to a pre-designed bottom half of the clamshell, that incorporates a series of grooves for directing the brewed beverage to an aperture, approximately centrally of the lower clamshell, dripping and delivering into the beverage cup, during brewing.

Essentially, the essence of the invention is to provide this clamshell structure, that can hold conveniently an individual packet or portion of the grounds to be brewed, plugging it into the dispenser by the user, for immediately dispensing, upon the pressing of an activation button, for a cup of a freshly brewed beverage, for consumption.

It is, therefore, the principal object of this invention to provide a clamshelled structure for holding a singular serving packet of the grounds of a beverage, in preparation for brewing and dispensing.

Another object of this invention is to provide for a clamshell device that is hydraulically sealed, when closed, and squeezed together into a pressure fit, so as to prevent any leakage of the delivered hot water, or the brewed beverage, other than downwardly into the arranged cup.

Still another object of this invention is to provide a clamshell device that incorporates, integrally, its own spray head, in its upper section, for delivery of water uniformly and disseminated over the entire upper surface of a packet or scoop of beverage grounds contained within the device during brewing.

Still another object of this invention is to provide an integrated brew basket, into the clamshell structure of a beverage brewing apparatus.

Yet another object of this invention is to provide for a type of folding apparatus, in the form of a clamshell, that may be inserted into the brewer horizontally, to provide for beverage brewing of an individual serving of coffee or tea directly into an individual cup.

Still another object of this invention to provide an arrangement of a check valve system, wherein when the clamshell of this invention is inserted, it must be fully connected into a hydraulic seal, before the check valve system will allow for the delivery of hot water, or brewing of any beverage.

Still another object of this invention is to provide a uniquely shaped internal cavity structure for a clamshell arrangement in which an single packet or scoop of beverage grounds locates, so that once the hot water is delivered to the clamshell, it will be properly oriented for initially spraying onto the packet, and collecting the brewed beverage therebelow for delivery directly into a downwardly arranged cup.

These and other object may become more apparent to those skilled in the art upon review of the summary of the invention as provided herein, and upon undertaking a study of the description of the preferred embodiment, in view of the drawings.

### BRIEF DESCRIPTION OF THE DRAWINGS

In referring to the drawings, FIG. 1 discloses the beverage brewer dispenser of this invention with the cup arranged for reception of the brewed beverage, showing the clamshell brewer of this invention in alignment with the dispenser slot into which it locates during brewing;

FIG. 2 provides a perspective view of the clamshell brewing apparatus of this invention;

FIG. 3 provides an oblique perspective view of the clamshell brewing apparatus of this invention;

FIG. 4 provides a cross-sectional view of the clamshell beverage brewing apparatus of this invention, taken along the line 4-4 of FIG. 2;

FIG. 5 discloses the opened clamshell of this invention and further shows an exploded view of the o-ring that provides for hydraulic seal, and a packet of grounds, before closure and usage;

FIG. 6 provides a top view of the top closure of the clamshell, before it is permanently sealed to the top of the clamshell;

FIG. 7 provides an internal view of the top half of the clamshell, showing the disseminating head;

FIG. 8 is a side view of the top half of the clamshell;

FIG. 9 is a back view of the top half of the clamshell;

FIG. 10 is a perspective view of the bottom half of the clamshell, showing the various grooves and delivery paths for the brewed beverage directed to a center aperture, for dispensing;

FIG. 11 is a plan view of the clamshell half shown in FIG. 10;

FIG. 12 is a bottom view of the clamshell bottom half as disclosed in FIG. 10;

FIG. 13 is back view of the clamshell bottom half;

FIG. 14 is a schematic view disclosing a system utilizing the clamshell apparatus of this invention in combination with its dispenser;

FIG. 15 discloses a modified schematic view of the system for brewing individual cups of a beverage though usage of the clamshell device of this invention, in combination with its dispenser;

FIG. 16 discloses a schematic view of the clamshell brewer of this invention; and

FIG. 17 discloses a holder for use in conjunction with the clamshell brewer for application to a brewing apparatus.

### DESCRIPTION OF THE PREFERRED EMBODIMENT

In referring to the drawings, and more specifically FIG. 1, a dispenser 1 of this invention is readily disclosed. It is uniquely designed to be of compact size so as to be available for brewing lesser amounts of a designated beverage, and more particularly, it has requirements for only brewing of a singular cup 2 of a brewed beverage. The dispenser 1, as previously explained, may have internal componentry that provides for the timed heating and dispensing of a particular quantity of hot water, generally in amounts sufficient to only fill the individual cup 2, during brewing and dispensing. These types of componentry, as previously explained, may be found in our prior U.S. Pat. No. 4,829,888 and others in the prior art.

More specifically, this dispenser includes an internally arranged slot 3, which interiorly thereof, will include a tube upon which the clamshell 4 of this invention may seat, to provide for the leak-proof delivery of hot water to the clamshell 4, and the dispenser will include a downward opening, inwardly of its surface 5, which allows for the dripping of the brewed beverage down into the cup 2, during usage.

A more thorough description of the clamshell 4 of this invention, for use for the individual brewing of a cup of heated beverage, will be subsequently explained.

In any event, various types of systems for brewing through the dispenser of this invention can be readily described and understood upon undertaking a review of FIGS. 14 and 15 of this application. As can be seen in FIG. 14, the dispenser may include, generally in its upper half, or within its back base structure, a reservoir to which either hot water may be delivered from the valve 7, or which can be poured therein from another container 8, as to be understood. The water is then either delivered by gravity, or pumped by means of the pump 9 through an upwardly disposed reservoir 10 which may contain a heater and may be arranged in the upper half of the dispenser 1, as can be understood. In this position, a control and timing mechanism as known in the art, and which may be operatively associated with the pump 9, or its circuitry arrangement 11, upon the initiation of a switch, can deliver the heated water to the clamshell structure, as schematically shown at 4, into its internal cavity, for filtering through a packet of the beverage grounds, and for dispensing downwardly by gravity, into the individual serving cup 2, as noted.

Or, as can be seen in FIG. 15, dispenser 1 can include a reservoir 12 which receives fresh water from the hydrant or supply line 13, and since the reservoir contains a heating element 14 therein, the water can be substantially heated, to a degree that provides for efficient brewing of any beverage upon delivery of said heated water, and the water can then be delivered by pumping, or by the pressure of the advancing heated water, through the time controlled and solenoid valve 15 for flowing to or overflowing into the location of the clamshell 16, under timed and temperature regulated conditions, that allows for the brewing of an individual cup 2 of a brewed beverage.

Thus, as can be understood from reviewing the concept of the beverage dispenser 1 of this invention, and the schematic path for the delivery, heating, and dissemination of hot water into the clamshell brewing apparatus of this invention, as explained in FIGS. 14 and 15, the overall concept of this invention for providing an individual brewed cup of beverage, can be readily understood. Thus, usage and application of the clamshell device, for holding an individual packet or supply of beverage grounds, can now be more appreciated.

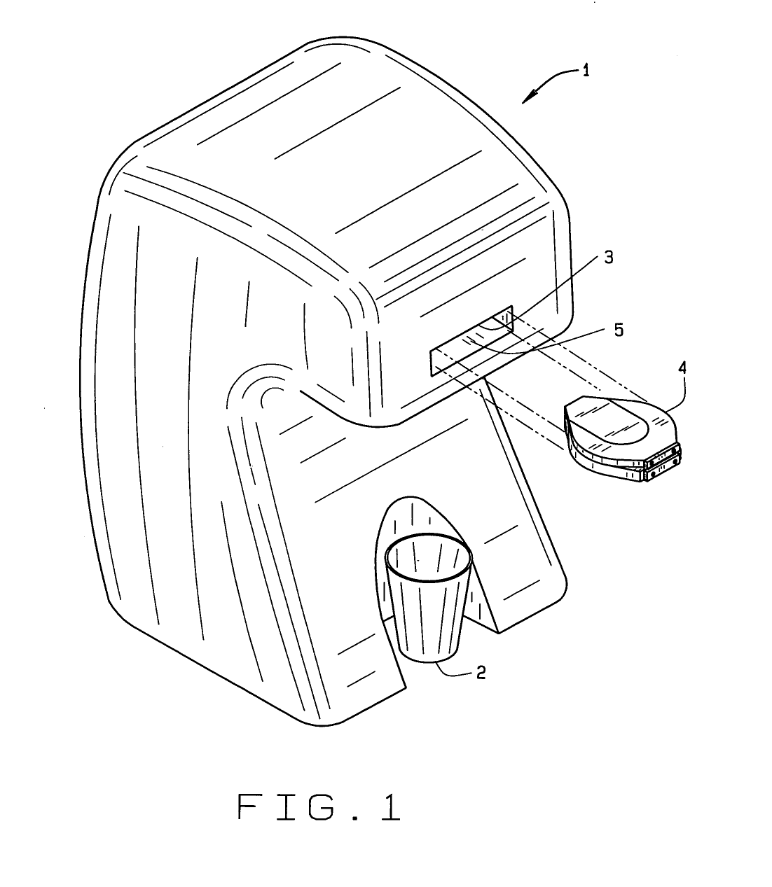

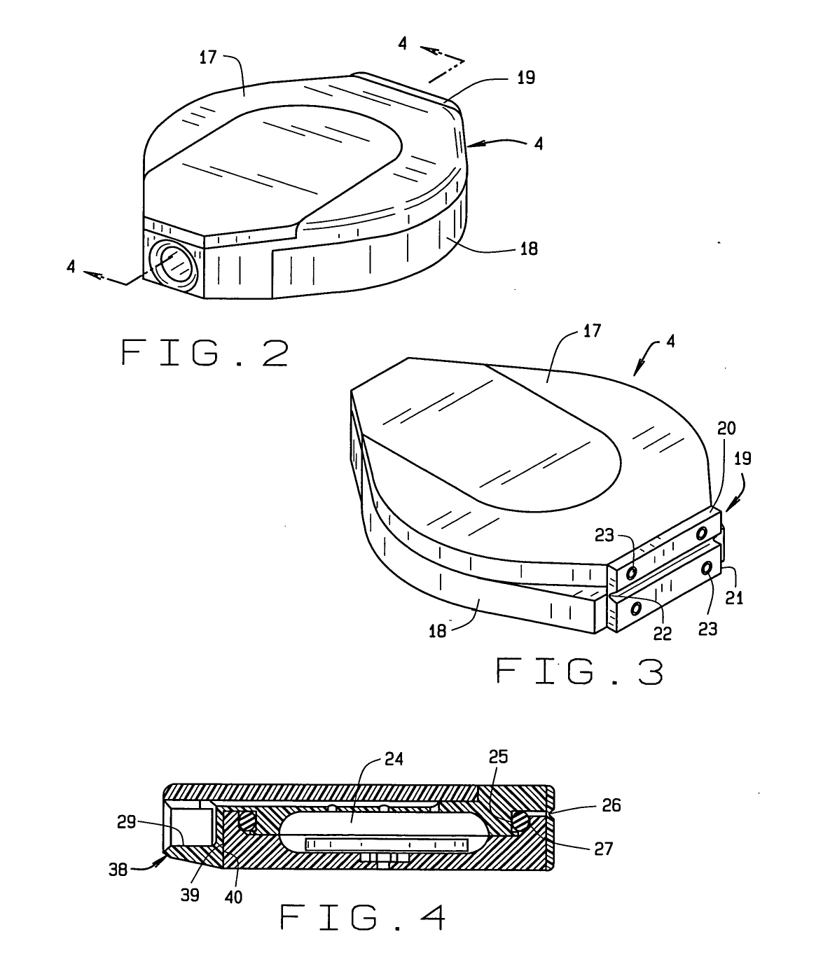

FIGS. 2 and 3 disclose the clamshell apparatus for this invention. As can be seen, the clamshell includes an upper clamshell half 17, a lower clamshell half 18, and the two clamshell halves will be held together into pivotal arrangement by means of the hinge structure 19, which may comprise a living hinge, having upper and lower sections 20 and 21, held together by the center score line formed hinge portion 22, as is understood. The hinge is held by fastening means 23 to the back upper and lower halves of the clamshell apparatus, as can be noted.

The entire combination of components that form the clamshell apparatus in this invention are disclosed in FIG. 5. As shown herein, the lower half 18 of the clamshell is disclosed, and is held by the hinge 19 to the upper half of the clamshell 17, as can be seen. A packet of grounds, as noted at B, will contain an individual supply of grounds sufficient to brew a cup of a beverage, and this is placed into the cavity 24, intermediate the interior of the upper and lower clamshell halves, when they are sealed into closure. The formed cavity 24 is more aptly disclosed in FIG. 4. In addition, the upper half of the clamshell includes a shoulder, as at 25, which extends downwardly, in the closed device, and upon this shoulder is snuggly retained an o-ring 26 that seals within an external shoulder 27, formed internally and upwardly of the lower clamshell half 18, as can be noted. Thus, with the use of the o-ring 26, when the clamshell is brought into closure, as can be seen in FIG. 4, a fluidic or hydraulic seal is formed for the clamshell, that prevents the leakage of any of the hot water delivered therein and thereto, during brewing.

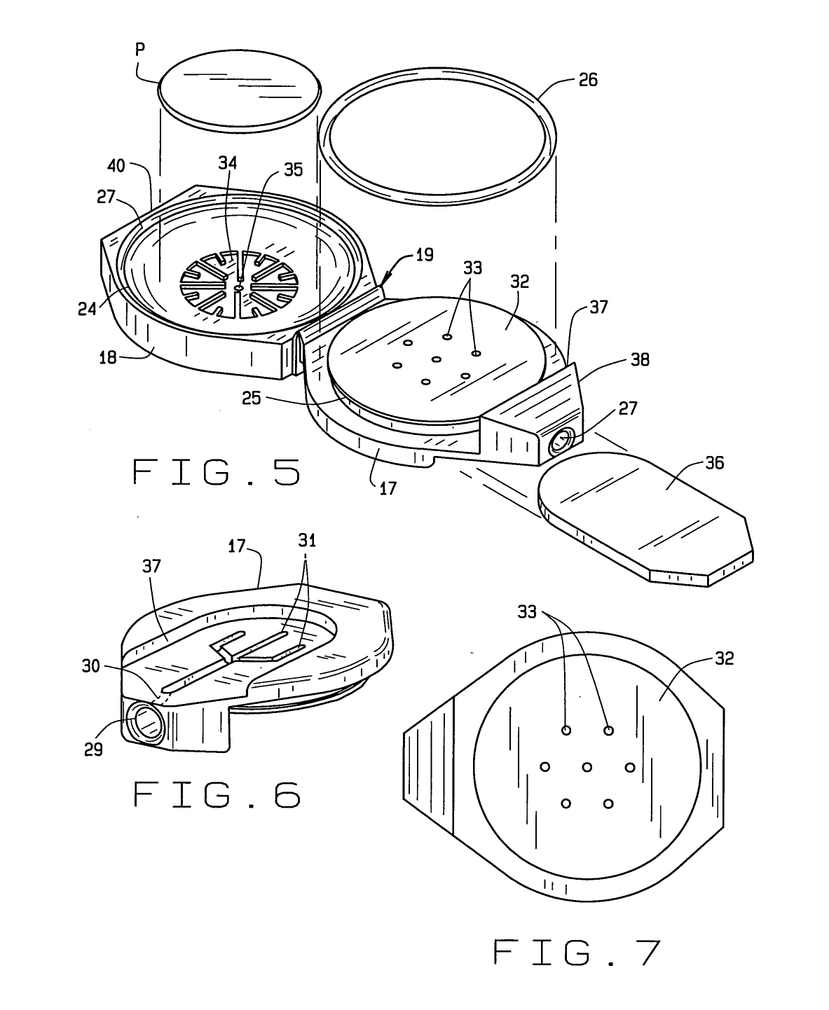

As can be seen in FIG. 6, during molding of the upper half of the clamshell 18, various internal grooves, as at 28, are formed, so that hot water entering into the clamshell, through its seating onto the delivery tube (not shown) of the dispenser, passing into the opening 29, will pass upwardly through the conduit 30, through the formed grooves 28, for dissemination along its various flow paths 31, and for delivery through the integrally formed spray head 32, out of its arranged flow apertures 33, of dispensing downwardly onto the packet P of the grounds located within the cavity 24. Obviously, this provides for a dissemination of the hot water over the entire upper surface of the packet P, to allow for filtration of the hot water through the packet, for leaching of the beverage from its contained grounds, and eventually delivering such brewed beverage into the lower half of the clamshell 18, and more specifically to its drainage con figured paths 34, to the dispensing aperture 35 for dropping into the individual beverage cup 2, as can be understood.

It is to be noted since the grooves 31 are formed internally of the upper clamshell half 17, while it is impossible to form or mold such grooves from a unified structure, a top surface plug 36, will be snuggly fitted and adhesively fused into the upper surface of the slot 37 to provide a sealed closure thereat. It can be seen from the combination of FIGS. 5 and 6, showing how the surface plug 36 is contoured to snuggly fit therein, and to be sealed within the slot 37, upon formation of the clamshell apparatus.

FIG. 7 provides a view of the internal upper surface of the upper clamshell half 17, as can be noted.

It should also be noted that the upper half of the clamshell includes an extending integral housing member 38, and this member includes the opening 29 that inserts onto the supply tube (not shown) that delivers the heated water from the dispenser 1 into the clamshell apparatus 4. The member contains a back wall surface, that snuggly fits against the front wall 40, and mates therewith, of the bottom clamshell half 18, when the clamshell is fitted and pressed into the closure. This can also be seen in FIG. 4.

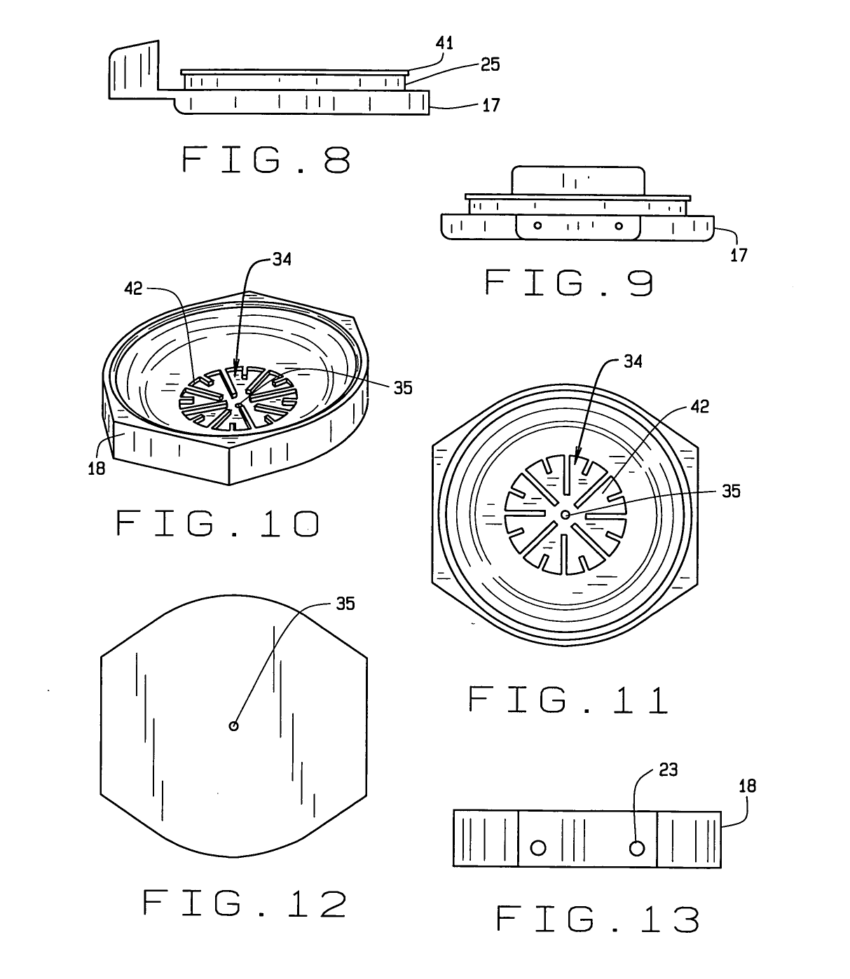

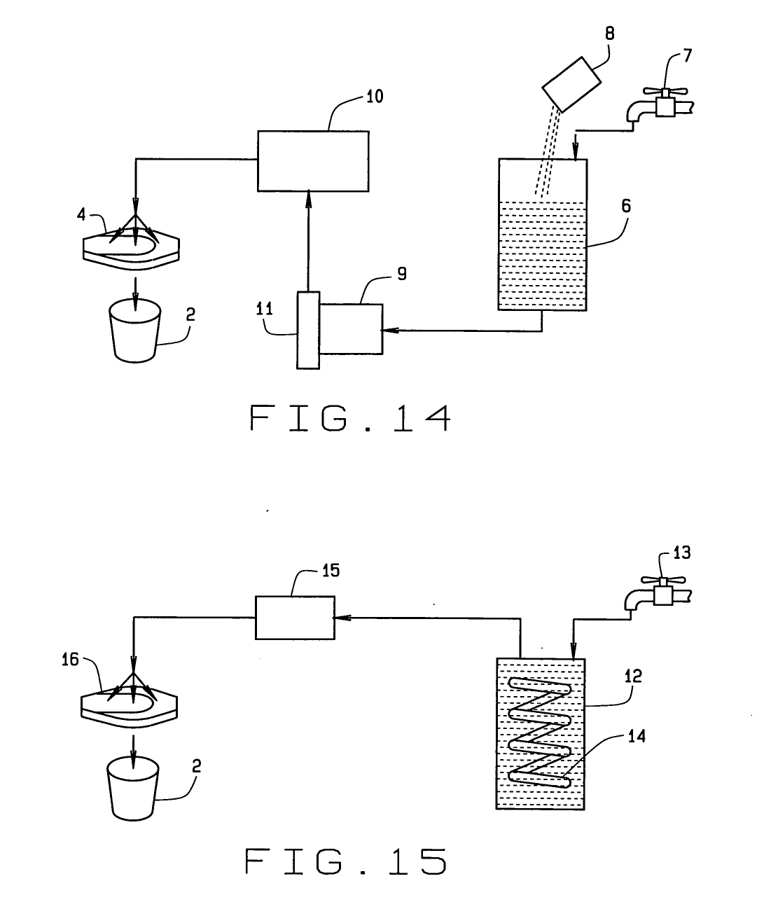

FIG. 8 shows a side view of the upper clamshell half 17, inverted, and discloses how a slight lip 41 may be provided around the shoulder 25, to insure retention of the hydraulic seal o-ring 26 thereon, once applied to the structure.

FIG. 9 provides a back end view of the upper clamshell 17. FIG. 10 discloses the bottom half 18 of the clamshell, and shows the various arranged ribs and grooves 34 that cooperate with a slightly slanted surface 42 for drainage of the brewed beverage, now having passed though the packet of beverage grounds, and directs the same towards the drip aperture 35, as previously explained. The same or more aptly disclosed in FIG. 11. In addition, the bottom view of the clamshell apparatus and its drip aperture 35, are readily disclosed. Also, a back view of bottom half 18 of the clamshell apparatus is shown and further discloses the openings to which the fasteners 23 secure the hinge 19 thereto, when assembling the clamshell apparatus into its useable configuration.

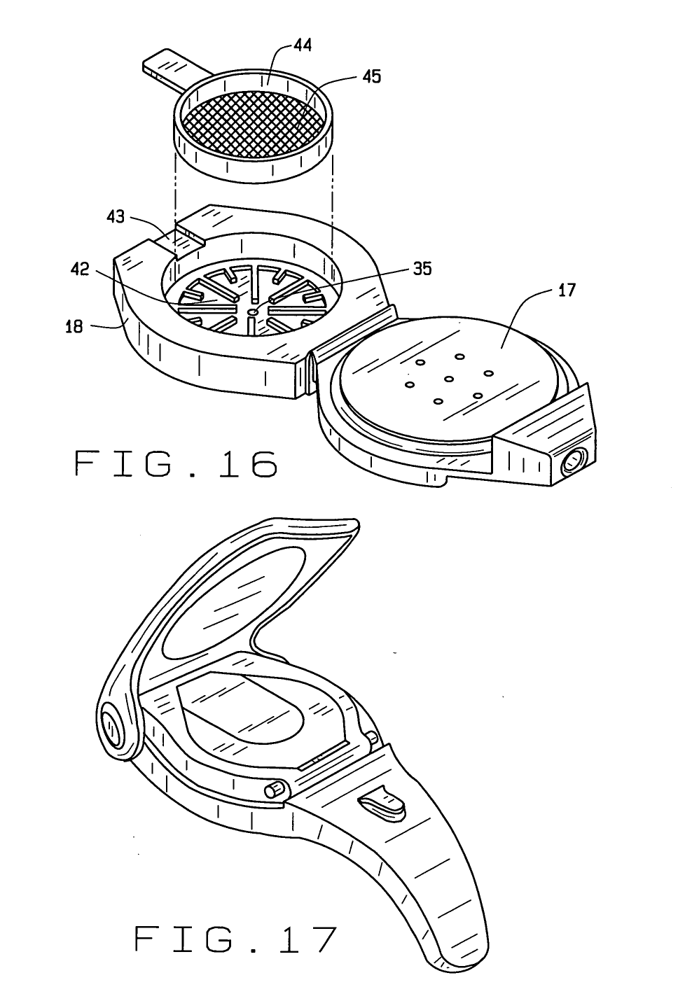

Modification to the usage of the clamshell apparatus of this invention can also be seen in FIGS. 16 and 17 as noted. The lower clamshell half 18 and its upper half 17 are modified only to the extent to provide a small clearance slot 43, along the front lip of the clamshell 18. This is designed for accommodating the locating of a measuring scoop 44 in the cavity 24, in lieu of the usage of the packet P, and the scoop includes a capacity, as can be noted, wherein an amount of beverage grounds may be located therein. The bottom of the scoop 44, as at 45, is formed as a filter, or as a foraminous screen, so that when hot water is delivered into the clamshell, and upon the scoop of grounds, it can filter therethrough and brew the desired beverage, and allow for the same to pass through the screen 45, and towards the bottom contoured surface 42 and through the drip aperture 35, directly into the single serving beverage cup 2, as previously explained. Thus, this shows how the clamshell feature of this invention can be integrated for usage even with a simple scoop of grounds, to provide for an individual brewing of a cup of beverage, such as coffee, and immediately dispense it into the cup 2, for consumption.

Usage of this invention is quite apparent that the user can apply a pad of the grounds for the coffee or tea into the clamshell, or perhaps a scoop of the same can be applied therein as in the modification, and the clamshell is closed. A hydraulic seal that is provided in combination with the top half of the clamshell seals the clamshell into closure, with the bottom half, and it does not require too much pressure to squeeze the two into a tight fluidic seal. When water enters the sealed chamber, or cavity, the line pressure of the water slightly expands the clamshell pressing the top and bottom halves against the inside walls of the slightly larger reception cavity of the brewer. This pressure holds the clamshell in the cavity while brewing, and once the pressure is relieved, the clamshell may be pulled from the cavity, after a dispensing cycle. It is essential that the cavity or chamber inside the clamshell remains fully sealed, regardless of any slight movement of the halves of the clamshell during a dispensing cycle. When the hot water is connected to the clamshell, through the dispenser, the water is routed up and over the sealed brew chamber, and into the spray head formation, as described, and down into the packet or scoop of grounds, as previously explained. Once the hot water passes through the grounds, within the brew chamber, the grooves in the bottom half of the clamshell have a tendency to collect the pressured hot beverage which slightly elevates the coffee pad or pod upwardly and away from the outlet hole, which is also maintained upwardly therefrom through the series of grooves or ribs that form the drain path in the lower half of the clamshell. This allows the water to flow therealong, and drain out the outlet aperture, as previously explained. When the clamshell is inserted into the brewer horizontally, the hole of the clamshell becomes connected with the hot water delivery tube (not shown) to make a connection of the clamshell with the waterline, as explained. In addition, it may be desirable that the inlet hole in the clamshell be shifted slightly off center, to prevent the clamshell from being inserted upside-down, during usage. The waterline fitting in the back of the brewer cavity has a built in check valve, that will not open unless the clamshell is fully inserted and sealed in the brewer or dispenser. A second check valve may be used in line that is between the brew cavity fitting and the tank. The second valve will open and direct water out of the hot water faucet if a brew cycle is started without the clamshell properly inserted within the dispenser. As previously stated, the bottom of the brew cavity is sloped to the center, so that any dripping from the clamshell or waterline fitting will be directed to the cup arranged therebelow, or any drip tray that may be provided.

When one initiates the brew button, this turns on a timer, which pumps cold water through the instant heater, then forces that water into the clamshell. In the second schematic as explained, the brew button turns on a timer which allows line pressure to move the water through the coil within the reservoir, to heat it, and then through a second solenoid valve into the clamshell for beverage brewing. This is an example of the steps undertaken integrally by the apparatus of this invention, when an individual portion of a beverage is to be brewed.

FIG. 17 discloses a holder for the clamshell brewer of this invention, said holder being adaptable for holding the clamshell device, as shown at 4, within the holder, for application to a brewing apparatus. It may be opened to apply a beverage filter therein and then reclosed for inserting into the brewer.

Obviously, variations and modifications can be made to the clamshell device of this invention in light of the disclosure of the concept, as provided herein. For example, it is just as likely that heated water can be delivered to the bottom half to the clamshell, filtered upwardly through the packet of grounds, overflowed into a trough for delivery to a dispensing aperture (not shown), for dripping into a serving cup. This is just an example as to how the clamshell can be modified, but still obtain the benefits of the conception of this invention, for furnishing an individually brewed cup of coffee or other beverage, as desired.

Further modifications or variations upon the subject matter of this invention may occur to those skilled in the art upon reviewing the invention as described herein. Such modifications, if determined upon reviewing the summary of this invention and undertaking a study of the description of its preferred embodiment in view of the drawings, are intended to be encompassed within the scope of the invention as described herein. The specific depiction of the invention, particularly as described, and as shown in the drawings, are set forth for illustrative purposes only. The concept is to provide an individually brewed cup of beverage through the use of a brewing type of instrument that is designed to hold an individual packet, or scoop of grounds, through which the controlled delivery of hot water will pass, for brewing an individual cup of the desired beverage.

1. A clamshell device for use in combination with a beverage brewing apparatus and for brewing a portion controlled amount of beverage for dispensing into a cup or other container, said clamshell device including an upper half and lower half, the upper and lower half of the clamshell device capable of being fluidly sealed together, a cavity provided within the clamshell device, and provided for holding a portioned amount of grounds of the beverage to be brewed, an intake opening provided into the clamshell device for delivery of heated fluids to the device, the upper and lower halves of the clamshell device having preformed paths for delivery of the heated fluids to a significant portion of the grounds, and said clamshell device having a drip aperture provided therein to allow for dispensing of the brewed beverage into an individual cup or other container for consumption.

2. The clamshell device of claim 1 and wherein said upper half of the clamshell device contains a series of grooves for passing the heated fluids for disseminating along its inner surface, and a series of apertures communicating with the grooves for spreading the heated fluids over the positioned grounds, the lower half of said clamshell device having a series of grooves for directing the brewed beverage towards its drip aperture, for dispensing of the brewed beverage towards a cup or other container.

3. The clamshell device of claim 2 wherein the portion of grounds are contained within a packet.

4. The clamshell device of claim, 2 wherein the portion of grounds are contained within a scoop, said scoop having a size and capable of inserting within the cavity of the clamshell device, in preparation for brewing of an individual amount of a beverage.

5. The clamshell device of claim 2 wherein the fluid intake opening being provided at the front of the clamshell device, and a hinge interconnecting the upper and lower halves of the clamshell device at its opposite end, and providing for a pivotal movement of the upper clamshell half with respect to the lower clamshell half during usage.

6. The clamshell device of claim 2 and including the means for providing a fluidic seal between the upper half and lower half of the clamshell device comprising an o-ring.

7. The clamshell device of claim 2 and including a handle extending integrally and rearwardly from one of the upper half or lower half of the clamshell device, for accommodating the application or removal of the clamshell device from the beverage dispenser for a brewing.

8. The clamshell device of claim 5 wherein the hinge is a living hinge.

9. The clamshell device of claim 5 wherein the fluid intake opening is off centered to assure the proper installation of said clamshell device into the beverage brewer.

10. The clamshell device of claim 2 and including a surface plug connecting with the upper half of said clamshell device to provide a seal for the fluid flowing through the grooves and provided for directing the heated fluids toward the disseminating apertures of the upper half of said clamshell device.

11. The clamshell device of claim 1, wherein said beverage brewing dispenser having a slot provided wherein, said slot having heated beverage flow tube provided therein, and said clamshell device capable of sliding within the brewer slot and for locating of said deliver tube within the clamshell device intake opening in preparation for brewing of a portion controlled amount of a beverage.

12. The clamshell device of claim 4 and wherein said scoop including a perforated bottom to allow for filtering of the brewed beverage therethrough for dispensing into the beverage cup or other container.

13. The clamshell device of claim 12 wherein said scoop includes a series of perforations provided within the bottom of said scoop to provide for dispensing of any beverage brewed to the individual cup or other container.
